(19) United States
(12) Patent Application Publication
(10) Pub. No.: US 2004/0049514 A1
(43) Pub. Date: Mar. 11, 2004

(54) System and method of searching data utilizing automatic categorization

(76) Inventor: Sergei Burkov, Los Altos, CA (US)

Correspondence Address: Thomas J. Brindisi, Esq., Suite B, 20 28th Place, Venice, CA, 90291, US

(21) Appl. No.: 10/653,369

(22) Filed: Sep. 2, 2003

Related U.S. Application Data
(60) Provisional application No. 60/409,382, filed on Sep. 11, 2002.

(51) Int. Cl. G06F 17/00

(52) U.S. Cl. 707/100

(57) ABSTRACT

A system and method for searching sources of data such as the World Wide Web for things such as available products and services, utilizing indexing of documents therein such as web pages and sites through automatic categorization based on their type, such as whether or not they offer products and/or services.

### RELATED APPLICATIONS

The present application claims the benefit of Provisional Application Ser. No. 60/409,382 filed on Sep. 11, 2002 and entitled “System of and method for improving searching the world wide web for products and services by automatically categorizing web pages,” the disclosure of which is incorporated by reference as if set forth fully herein except to the extent of any inconsistency with the express disclosure hereof.

### FIELD OF THE INVENTION

The present invention relates to systems and methods for searching sources of data such as the World Wide Web (“the Web”). In particular, one preferred embodiment of the present invention relates to an improved system and method of searching that utilizes automatic categorization of web pages and sites based on their type, such as whether or not they offer products and/or services.

### BACKGROUND OF THE INVENTION

One way to search the Web for products and services is to employ a general purpose web search engine such as Google®, Yahoo®, Overture®, Alltheweb®, Inktomi®, AltaVista®, or the like. Such search engines may be able to reach an extremely vast array of e-commerce sites, but along with sites and pages actually offering products or services, they generally also return many sites and pages that merely describe, review, discuss, or otherwise mention the product or service being searched.

“Comparison shopping engines” such as BizRate®, DealTime®, PriceGrabber® and the like permit more focused searching of the Web for specific products or services that are desired to be obtained. The traditional comparison shopping engines search through only a limited number of e-commerce sites that are pre-selected by human editors, however, and also tend to focus on highly popular, mass-marketed products, to the exclusion of other items such as industrial products.

### SUMMARY OF THE INVENTION

A system for searching a data source utilizing automatic categorization, according to the present invention, comprises a means for categorizing a plurality of documents in the data source, a category index that contains categorization information received from the automatic categorization means, means for receiving a user query, searching means for executing the user query on the data source and returning a list of documents satisfying the user query, means for checking the returned list of documents against the category index and manipulating the list of documents based thereon, and means for returning to the user the manipulated list of documents. A method of searching a data source utilizing automatic categorization, according to the present invention, comprises the steps of applying an automatic categorization algorithm to documents in the data source, storing resulting categorization information in a category index, receiving a user query, causing searching means to execute the user query on the data source and return a list of documents satisfying the query, checking the returned list of documents against the category index and manipulating the list of documents based thereon, and returning the user a manipulated list of documents. Thus, for example, an embodiment of the present invention can be made that permits extremely broad searching of the Web, but returns results limited to web sites and/or pages at which one can obtain a desired product or service, while excluding other sites and pages that only contain other content.

### DESCRIPTION OF PREFERRED EMBODIMENTS

In one preferred embodiment, the present invention may comprise a standalone categorization search site that operates in conjunction with one or more conventional search engines, and is hosted on computing means that are separately maintained and physically remote from the computing means hosting the search engine(s). Such an embodiment may operate as follows:

1. Automatically (e.g., periodically) and/or at the direction of an administrator, a computer program of the categorization search site known as an information retrieval “robot” or “bot” crawls the Web to retrieve copies of web pages maintained on remote web servers (the number of which may optionally be limited to less than all accessible pages). The retrieved pages are (preferably automatically) then processed by a categorization program of the categorization search site that determines automatically (i.e., without human intervention) if they belong to one or more predefined categories, and then stores the corresponding Universal Resource Locators (“URLs”) and categorization data in a “category index” database maintained by the categorization search site. Optionally, the number of records to be stored may be limited, and/or records optionally may be automatically deleted after a certain period of time, and/or the URLs optionally may be abridged so that only domain names are stored.

2. A user accesses (e.g., remotely over the internet) an interface of the categorization search site and enters a search request (“query”), which is automatically conveyed to one or more conventional search engine sites. Optionally, the user may be offered the choice to obtain only search results that belong to one or more categories specified by the user, and/or optionally may be offered the choice to limit the number of search results, and/or a preset limit may optionally be imposed, and/or meta-search techniques and the like optionally may automatically be applied to the outgoing query.

3. The search engine(s) return(s) to the categorization search site a results list deemed to satisfy the query, along with other information such as brief summaries. Optionally, the categorization search site may truncate the list to any limit specified in step 2, and/or optionally may modify the list to prune out non-unique pages and/or abridge URLs to just domain names.

4. Preferably, the categorization search site automatically checks the URLs of the list against the category index, utilizes the information retrieval bot to retrieve copies of pages having URLs not found in the category index, and causes those pages to be processed and added to the category index as described above.

5. Category information is obtained and a limited (by number of results and/or category type per step 2) and/or categorized results list is displayed to the user. Category information may be obtained either at once by retrieval from the updated category index produced by step 4, or in parts, e.g., by retrieving information for all web pages found in the index existing prior to step 4 and then directly adding to that retrieved information the further category information produced in step 4. Optionally, the results list may include corresponding category information and/or any other desired information commonly displayed by conventional search engines, and the user optionally may also be offered a choice to further manipulate the displayed results. For example, if more than one category is displayed, means to (re-)sort them by category and/or block specified categories from view may be provided. The user's search results optionally may also be logged as is well-known in the art.

By employing multi-threading and load distribution among multiple computers, certain of these steps could be started without waiting for completion of all the preceding steps, as is commonly practiced in the field; for example, the automatic categorization program could begin analyzing the web pages already retrieved while the bots continue retrieving more pages from the Web, and/or categorization information could be retrieved from the category index while web pages are being retrieved from the Web, et cetera.

It is noted that in a variation of the embodiment described above, some or all of the information retrieval bots, categorization program, category index, interface, et cetera could be hosted by computer means located at the end-user's premises rather than at a categorization search site. In yet another embodiment, the information retrieval bot(s), categorization program, category index, interface, et cetera could be hosted by the same server means that hosts an otherwise conventional search engine, in which case they could be seamlessly integrated with the global index(es), information retrieval bots, user interfaces, and other components of the search engine. In this case, step 1 could be performed concurrently with the general indexing of web pages.

It is also noted that a system according to the present invention is preferably capable of receiving input from and/or delivering output to user(s) that are human or otherwise. A suitable human user interface may preferably include a graphical user interface provided by a client software application running on the user's computer, as well as a web browser interface, as is commonly practiced in the field. A suitable machine input/output interface may preferably comprise or include SOAP, XML Web Services, CORBA, Microsoft.Net, proprietary local and remote interfaces, et cetera.

The automatic categorization program can be a software implementation of any suitable categorization algorithm such as the well-known Support Vector Machines, k^{th} Nearest Neighbor, Rocchio, Regression Trees, Neural Networks, Sleeping Experts, inductive rule learning, Naive Bayesian classifiers and the like. (See “The elements of statistical learning—data mining, inference and prediction” by Hastie, Tibshirani and Friedman (Springer Verlag, 2001, ISBN: 0387952845), and “Classification and Regression Trees” by Leo Breiman (Kluwer Academic Publishers, 1984; ISBN: 0412048418), the disclosures of which are incorporated herein by reference). Most such algorithms include, as their initial step, an automatic variable selection based on the manual selection and categorization of, e.g., a few thousand documents called a “training corpus.” The algorithm finds the variables (words, characters, and combinations thereof) most common among the documents in the training corpus, and then uses those variables in categorizing subsequent documents.

A preferred implementation of a categorization algorithm for use in the present invention, however, may preferably include one or both of two salient modifications. First, although all HTML tags, JavaScript source code symbols, and other markups are generally removed from web pages (leaving only ASCII text) before feeding them into a categorization algorithm, it may be preferable in the present invention to feed the entire HTML document including all of its source code, metatags, markup symbols, and the like into the algorithm (although HTML tags are preferably selectively removed from the variable list as noted below). For instance, using an example in the context of categorizing pages into shopping versus non-shopping, the string “<b> Price <font size=+2> $99.00 </font> </b>” may be more advantageous than the mere string “Price $99.00”.

Second, it may be preferred to modify a categorization algorithm for use in the present invention by manually editing—removing from and/or adding to—the variable list it automatically produces. This may be advantageous because more sophisticated logic can be utilized and a broader context can be taken into account when deciding which variables should be included in the list. In adding variables to the list, an editor examines the training corpus for variables that are common among documents in the training corpus but missed by the algorithm. For example, algorithms may tend to miss long word combinations (e.g., “Add to your shopping cart”) that can be readily manually identified. Conversely, in removing variables from the list, an editor examines the training corpus for variables that are common among documents in the training corpus but less indicative of the desired category. (For example, the common string “Designed and hosted by XYZ company” is not likely a strong determinant for a shopping category). The number of variables manually removed from and added to the list is discretionary, but the number of originally automatically selected variables remaining after manual removal may preferably be comparable with or smaller than the number of manually added variables, so as to balance the relative weight given to variables selected by the algorithm and human editors. A preferable process for selecting and modifying an algorithm for use in a categorization program of the present invention may thus proceed as follows:

1) Manually select and classify into desired categories a few thousand web pages so as to create a training corpus (preferably with at least two people classifying each page so as to minimize human judgment errors).

2) Similarly select and classify another set of web pages as a “test corpus.”

3) Train several text categorization algorithms on the training corpus as is well-known in the art.

4) Have humans review the lists of variables automatically selected by each algorithm, and modify each algorithm by selectively removing any desired variables and selectively adding any desirable variables to each of the algorithms' lists.

5) Apply the modified algorithms to the test corpus, calculate their respective error rates, and select the modified algorithm that demonstrates the lowest error rate.

Preferably, one or more of the steps in this process (particularly steps 3-5) may be iteratively repeated to seek a modified algorithm with a further lowered error rate. It may also be preferable to repeat the process occasionally over time to accommodate the ongoing evolution the Web's content, as well as any potentially more accurate text categorization algorithms that are developed later.

In a preferred embodiment of the present invention, the predefined categorization of web pages and web sites preferably includes a basic categorization between a “shopping” category and a “non-shopping” category, wherein the “shopping” category is limited to web pages and sites offering products (and/or services). The “non-shopping” category may include all other pages and sites, or it may be limited to “non-shopping” pages and sites that relate to but do not offer products (which typically includes, e.g., online magazine and newspaper articles, reviews, descriptions, discussions, opinions, bulletin boards, newsgroups, personal web pages, and the like). By way of example, the following is a list of manually selected variables for addition (as part of step 4 above) that has been found to be advantageous for selecting a category limited to shopping for products:

| | | |
|---|---|---|
| my cart | add to cart | shopping cart |
| add to basket | view cart | items in cart |
| add to your shopping cart | view all carts | add cart |
| add to order | shopping basket | view shop cart |
| view your cart | add to cart | add to basket |
| add to your shopping cart | add items to your order | add cart |
| add one to basket | add to shopping cart | buy now |
| buy it now | buy one now | buy this item now |
| buy on line | order now | buy online |
| click here to purchase | click here to order | order this item |
| show order | view order | secure online order |
| order tracking | online ordering | secure online shopping |
| ordering info | Show my order | track your order |
| click here to order | click to order | ordering instructions |
| ordering<BR>instructions | how to order | have a salesperson contact me |
| contact a salesperson | contact a sales person | have a sales person contact me |

It is noted that even for the selection of a product shopping category, however, this or any other list cannot be considered perfect, because different list and algorithm combinations will exhibit different performance characteristics under different conditions, and the comparison of performance inherently involves a degree of subjective and/or offsetting factors.

In other embodiments of the invention, different main categories, and/or further divisions of the main categories into sub-categories, may also be defined and implemented in similar fashion to the foregoing example of “shopping” and “nonshopping” categories, with the selection of manually added and removed variables (if any) and the like depending upon the respective categories to be implemented in the particular embodiment. As one of many possible examples, the “shopping” category described above might be divided into online stores, “brick-and-mortar” (physical) stores, comparison shopping sites, online classifieds, auctions, real estate agencies, travel agencies, and/or other such subcategories, while the “non-shopping” category might be divided into magazine and newspaper articles, reviews, descriptions, discussions, opinions, bulletin boards, newsgroups, personal web pages and/or other such subcategories. Such subcategories could also optionally be hierarchically structured; for example, sub-subcategories of “online stores” and “brick-and-mortar” (physical) stores could comprise a single “stores” subcategory. In any case, the scope and nature of the particular predefined categories (and any subdivisions within them) of an embodiment of the present invention are preferably communicated to the prospective users.

It will be understood that each of the elements and/or steps of the method described above, or two or more together, may also find a useful application in other types of constructions and/or methods differing from the types described above. While preferred embodiments have been described in the context of searching the internet with internet search engines, the present invention can likewise be applied to other sources of data than the internet, such as intranets, databases, etc., in which case the web search engine could be replaced with any searching means (e.g., site search engines, intranet search engines, and software applications that find and retrieve information from single or multiple databases, including ones utilizing SQL and/or ODBC) suitable to the data source such as is well-known in the art. Moreover, while a preferred embodiment has been described in the context of a shopping/non-shopping categorization, the invention is not limited to such categorizations. Instead, the invention is limited only as set forth in the following claims and their legal equivalents.

What is claimed is:

1. A method of searching a data source utilizing automatic categorization, comprising the following steps:
a) applying an automatic categorization algorithm to a plurality of documents in the data source;
b) storing categorization information resulting from step a) in a category index;
c) receiving a user query from a user;
d) causing one or more searching means to execute said user query on part or all of the data source so as to identify and return a list of some or all documents therein that satisfy said user query;
e) checking said list of some or all documents returned in step d) against said categorization information stored in said category index;
f) manipulating said list of documents based on information derived from said checking; and,
g) returning to said user a manipulated list of documents.

2. The method of claim 1, wherein said step of manipulating includes limiting said list of step d) to exclude documents that do not fall within one or more selected categories.

3. The method of claim 1, wherein said step of manipulating includes the step of ordering said list of step d) into one or more selected categories.

4. The method of claim 1, wherein said step of manipulating includes the step of marking up entries in said list of step d) according to their categories.

5. The method of claim 1, further comprising the step of providing said user with further information relating to said manipulated list of documents.

6. The method of claim 1, wherein step e) is performed on a computing means separate and remote from the computing means on which said one or more searching means are hosted.

7. The method of claim 1, wherein step e) is performed as part of step d) and said category index is integrated into a searching means' global index.

8. The method of claim 1, wherein step a) categorizes said documents according to whether or not they fall into a predefined “shopping” category.

9. The method of claim 8, wherein said predefined “shopping” category is limited to documents that offer products.

10. The method of claim 1, wherein at least one of said one or more searching means is a web search engine, and said documents are web pages.

11. The method of claim 10, further comprising the steps of, after steps a) and b) have been performed at least once, performing steps a) and b) on any web pages returned in step d) that are not represented in said category index.

12. The method of claim 1, further comprising the steps of, after steps a) and b) have been performed at least once, performing steps a) and b) on any documents returned in step d) that are not represented in said category index.

13. A system for searching a data source utilizing automatic categorization, comprising:
a) automatic categorization means for categorizing a plurality of documents in the data source;
b) a category index that contains categorization information received from said automatic categorization means;
c) means for receiving a user query from a user;
d) means for causing one or more searching means to execute said user query on part or all of the data source so as to identify and return a list of some or all documents therein that satisfy said user query;
e) means for checking said list of some or all documents returned by said searching means against said categorization information contained in said category index;
f) means for manipulating said list of documents based on information derived from said checking means; and,
g) means for returning to said user a manipulated list of documents.

14. The system of claim 13, wherein said means for manipulating include means for excluding documents not meeting one or more selected categories.

15. The system of claim 13, wherein said means for manipulating include means for ordering results by category.

16. The system of claim 13, wherein said step of manipulating includes the step of marking up entries in said list of step d) according to their categories.

17. The system of claim 13, further comprising means for providing said user with further information relating to said manipulated list of documents.

18. The system of claim 13, wherein said system is hosted on computing means separate and remote from those hosting said one or more searching means.

19. The system of claim 13, wherein said system is hosted on computing means that hosts at least one of said one or more searching means, and said category index is integrated into that at least one searching means' global index.

20. The system of claim 13, wherein said automatic categorization means is adapted to categorize documents according to whether or not they fall into a predefined “shopping” category.

21. The system of claim 20, wherein said predefined “shopping” category is limited to documents that offer products.

22. The system of claim 13, wherein at least one of said one or more searching means is a web search engine, and said documents are web pages.

23. The system of claim 22, further comprising means for updating said category index in response to the return by said web search engine of any web pages identified that were not previously represented in said category index.

24. The system of claim 13, further comprising means for updating said category index in response to the return by said searching means of any documents identified that were not previously represented in said category index.
